(19) United States
(12) Patent Application Publication
(10) Pub. No.: US 2004/0222624 A1
(43) Pub. Date: Nov. 11, 2004

(54) Enclosure for a child

(76) Inventor: Anne M. Diebel, Mercerville, NJ (US)

Correspondence Address: GREENBERG TRAURIG LLP, 2450 COLORADO AVENUE, SUITE 400E, SANTA MONICA, CA, 90404, US

(21) Appl. No.: 10/435,097

(22) Filed: May 9, 2003

(51) Int. Cl. B42D 3/00

(52) U.S. Cl. 281/29

(57) ABSTRACT

A combination book and enclosure has a series of panels, at least one of the panels having a printed feature. The panels are in end to end relationship around a hinge line so as to be foldable in a fan-like mode and the first panel and the last panel in the series having respectively free-ends. The free end of the first panel and the fee end of the last panel are connectable together when the panels are opened and extended such that the free ends can be brought into contact. A connection feature of the free end of the first panel are for mating engagement with the a complementary mating connection feature on the free end of the last panel. The panels in a first mode are readable sequentially as a book when successive panels are sequentially turned about the hinge line between the panels. The panels in a second mode are extendible from the front panel to the last panel and the respective connection features are brought into mating engagement thereby to form an enclosure.

### BACKGROUND OF THE INVENTION

Field of the Invention

This invention relates to a children's or baby's book and a child or baby enclosure.

Baby books are well known, and baby enclosures are also well known. Each has its advantages.

This invention is directed to achieving an advantageous system of securing the enclosure and also for obtaining the benefit of both a book and an enclosure in a single product.

### SUMMARY OF THE INVENTION

A combination book and enclosure has a series of panels, at least one of the panels has a printed feature. The panels are in end to end relationship around a hinge line so as to be foldable in a fan-like mode. The first panel and the last panel in the series have respectively free-ends. The free end of the first panel and the fee end of the last panel are connectable together when the panels are opened and extended such that the free ends can be brought into contact.

A connection feature of the free end of the first panel is for mating engagement with the a complementary mating connection feature on the free end of the last panel. The panels in a first mode are readable sequentially as a book when successive panels are sequentially turned about the hinge line between the respective panels.

The panels in a second mode are extendible from the front panel to the last panel and the respective connection features are brought into mating engagement thereby to form an enclosure.

In a preferred form each panel has a printed feature which is self contained on one face of the respective panels. The printed features on the reverse faces of at least two adjacent panels is a printed feature which overlaps thematically. Preferably, all the reverse panels overlap thematically from one panel to the adjacent panel thereby creating a wrap around theme. The panels on the front are preferably thematically related to the panels on the rear.

In another form the printed features overlap on both front panels and reverse panels. Related themes can be created between the front and reverse panels.

Preferably, the connection feature on a front panel and the last panel are mating jigsaw cut out shapes in the free ends.

In yet another form of the invention there is a collapsible enclosure which comprises a series of panels, at least some of the panels having decorative features. The panels are locatable in end to end relationship with the free end of a first panel and the fee end of an adjacent panel being connectable together when the panels are placed in a relative extended relationship such that the free ends can be brought into contact.

A connection feature of the free end of a first panel is for mating engagement with a complementary mating connection feature on the free end of an adjacent panel. The panels are extendible to form the enclosure. Between at least two adjacent first and last panels there are respective connection features brought into mating engagement thereby to form an enclosure. The connection feature on the first panel and the adjacent panel are mating jigsaw cut out shapes in the free ends.

The invention is now further described with reference to the accompanying drawings.

### BRIEF DESCRIPTION OF THE DRAWINGS

FIG. 1 is a perspective view of the panels as an enclosure;

FIG. 2 is a perspective view of the panels as a book;

FIG. 3 is a perspective view of the first and last panels closed with jigsaw formations;

FIG. 4 is an open view of one side of the panels; and

FIG. 5 is an open view of the opposite side of the panels.

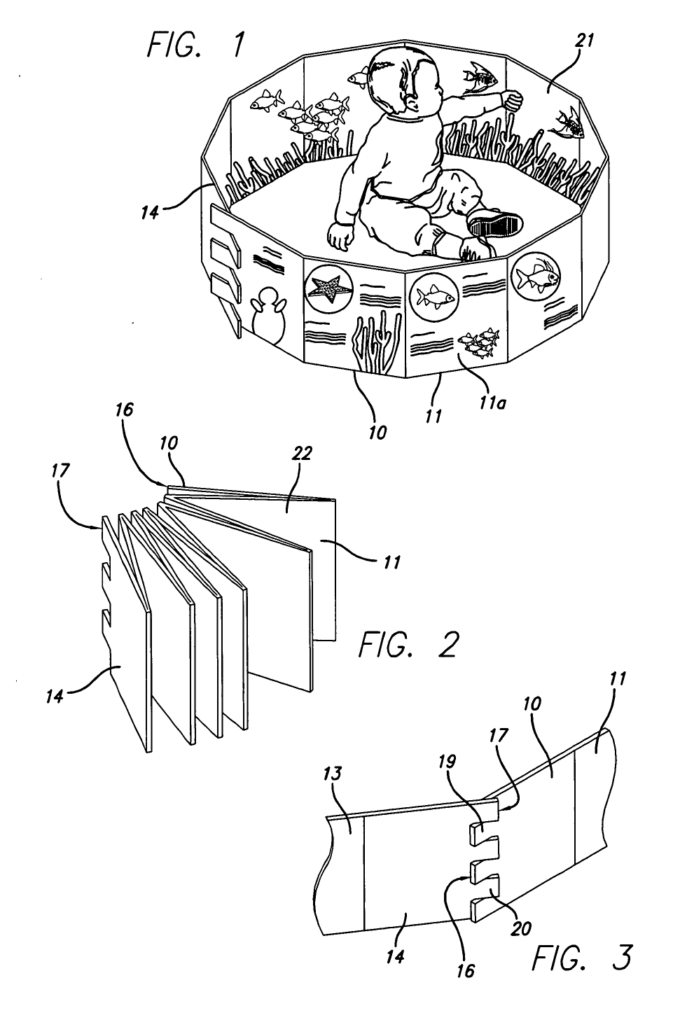

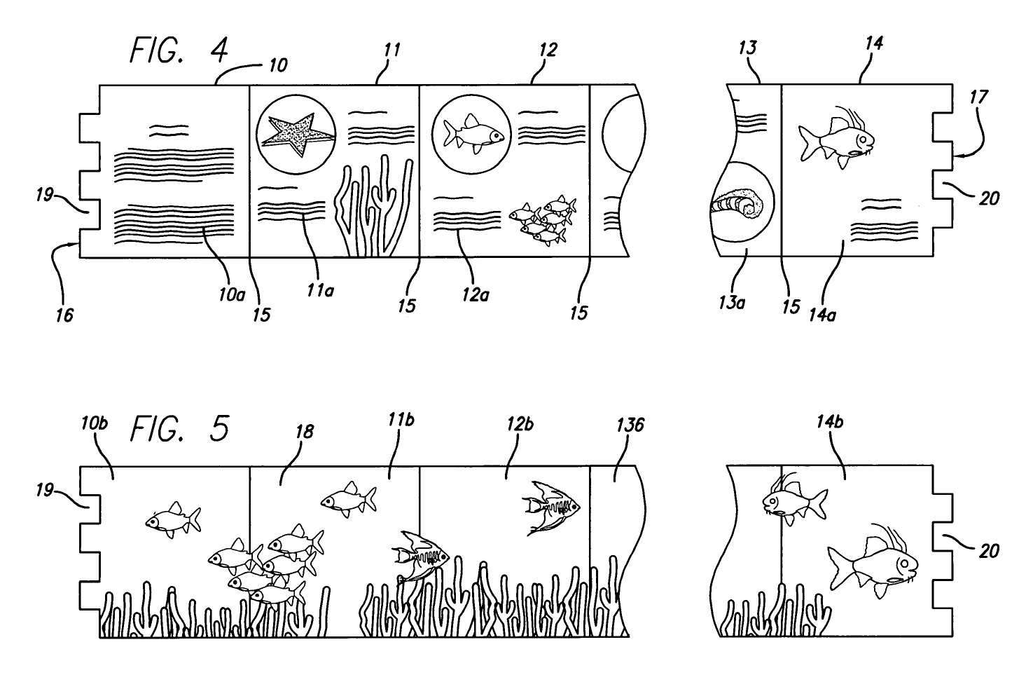

### DETAILED DESCRIPTION OF THE INVENTION

A combination book and enclosure has a series of panels 10, 11, 12, 13, and 14, and at least one of the panels 10 to 14 has a printed feature 10a, 11a, 12a, 13a, or 14a.

The panels are in end to end relationship around hinge lines 15 so as to be foldable in a fan-like mode. The first panel 10 and the last panel 14 in the series having respectively free-ends 16 and 17. The free end 16 of the first panel 10 and the fee end 17 of the last panel 14 are connectable together when the panels 10 to 14 are opened and extended such that the free ends 16 and 17 can be brought into engagement.

Each panel 10 to 14 is sized to be about 12 to 15 inches in height and about 8 to 10 inches in width. The thickness of each panel 10 to 14 is about ¼ to ½ inches. Each of the panels 10-14 is formed of a corrugated board material which is covered with a smooth face. Between the ends of each panel, adjacent the hinges lines 15, the panels 10 to 14 are thinned so that there is no corrugations between the face material. As such, the thinned material facilitate forming the hinged line 15 between adjacent panels. A printed or decorative format 10a to 14a is pasted on the panels 10 to 14 on the front face. A printed or decorative format is formed on the reverse faces 10b, 11b, 12b, 13b, and 14b to form a continuous theme 18 across all the faces 10b to 14b.

A connection jigsaw feature 19 of the free end 16 of the first panel 10 is for mating engagement with a complementary mating connection jigsaw feature 20 on the free end 17 of the last panel 14. The connection feature on a front panel and the last panel are mating jigsaw cut out shapes 19 and 20 in the free ends 15 and 17. The jigsaw feature 19 and 20 have three extending protrusions between three interplaced slots at the end of each of the first panel 10 and the last panel 14. The protrusions and the slots of the first panel 10 are oppositely located relative to the slot and protrusions of the last panel 14. The height of each protrusion and slot is substantially the same so that the respective oppositely located front 10 and rear 14 panels. As such these panels can be interlocked and the enclosure 21 formed.

The panels 10 to 14 in a first mode are readable sequentially as a book 22 when successive panels are sequentially turned about the hinge line 15 between the panels 10-14. Since the book is a fan-like format the hinges 15 are respectively at the opposite ends of each panel, except for the free ends of the first 10 and rear 14 panels.

The panels 10 to 14 in a second mode are extendible from the front panel 10 to the last panel 14 and the respective connection features 19 and 20 are brought into mating jigsaw engagement thereby to form the enclosure 21.

Each panel 10 to 14 has a printed feature 10a, 11a, 12a, 13a, and 14a which is self-contained on one face of the respective panels. The printed features 10b, 11b, 12b, 13b, and 14b on the reverse faces of at least two adjacent panels are a printed feature which overlap thematically. The thematical overlap from one panel to the adjacent panel thereby creates a wrap around theme for the enclosure 21.

In another form the printed features on both fronts 10a to 14a and the reverse 10b to 14b are thematically related and/or overlap thereby to create related themes between the front and reverse panels 10a to 14a and 10b to 14b.

In another example, the collapsible enclosure 21 comprises a series of panels 10 to 14, at least some of the panels 10 to 14 having decorative features. The panels 10 to 14 are locatable in end to end relationship with the free end 16 of a first panel 10 and the free end 12 of an adjacent last panel 14 being connectable together. When the panels 10 to 14 are placed in a relative extended relationship the free ends 16 and 17 can be brought into contact.

The connection feature 19 of the free end 16 of a first panel 10 is for mating engagement with a complementary mating connection feature 20 on the free end 17 of an adjacent panel 14. The panels 10 to 14 are extendible to form the enclosure such that the respective connection features 19 and 20 brought into mating engagement form the enclosure 21.

Many other forms of the invention exist, each differing from the other in matters of detail only.

For instance, the shape of the jigsaw formations may be different to the square like protrusions and slots formed at the end of the respective panels. Different tongue and groove formations and shapes can be used.

The invention also includes having the feature of the enclosure formed with the protrusion and slots, even though there may be no book feature. The folding feature of the panels 10 to 14 without the thematically formed book material but having the jigsaw connections is also a part of the invention. Some or all of the panels may have windows. More than one set of jigsaw connections can be provided between different panels. Thus, there can be two or more different jigsaw connected panels for the enclosure.

1. A combination book and enclosure comprising a series of panels having a first panel and a last panel, at least one of the panels having a printed feature; wherein:
each two adjacent panels are in end to end relationship around a hinge line so as to be foldable in a fan-like mode, the first panel having a first panel free end and the last panel having a last panel free end;
the first panel free end and the last panel free end are connectable together when the panels are opened and extended such that the first panel free end and the last panel free end can be brought into contact;
a first panel connection feature on the first panel free end is for mating engagement with a complementary last panel connection feature on the last pane) free end;
the panels in a first mode are readable sequentially as a book when successive panels ale sequentially turned about hinge lines between the panels; and
the panels in a second mode are extendible from the first panel to the last panel and the first panel connection feature and the last panel connection feature are brought into mating engagement thereby to form an enclosure suitable to enclose a child.

2. A combination as claimed in claim 1 wherein each panel has a first face and a second face, each panel having a printed feature which is self contained on the first face.

3. A combination as claimed in claim 2, wherein printed features on second faces of at least two adjacent panels form a thematically overlapping printed feature.

4. A combination as claimed in claim 3 wherein the printed features on the second faces of all panels form the thematically overlapping printed feature, thereby creating a first wrap around theme.

5. A combination as claimed in claim 1 wherein each panel has a first face comprising a first face printing feature and second face comprising a second face printing feature, first face printing features of all panels thematically overlapping to create a first face wrap around theme, and second face printing features of all panels thematically overlap ping to create a second face wrap around theme, the first ace wrap around theme related with the second face wrap around theme.

6. A combination as claimed in claim 1 wherein the first panel connection feature and the last panel connection feature are mating jigsaw cut out shapes in the first panel free end and the last panel free end.

7. A combination book and enclosure comprising a series of panels having a first panel and a last panel, at least some of the panels having printed features; wherein:
each two adjacent panels are in end to end relationship around a hinge line so as to be foldable in a fan-like mode, the first panel having a first panel free end and the last panel having a last panel free end;
the first panel free end and the last panel free end are connectable together when the panels are opened and extended such that the first panel free end and the last panel free end can be brought into contact;
a first panel connection feature on the first panel free end is for mating engagement with a complementary last panel connection feature on the last panel free end;
the panels in a first mode are readable sequentially as a book when successive panels are sequentially turned about binge lines between the panels, all of the hinge lines between the panels of the series of panels being substantially in a same direction;
the panels in a second mode are extendible from the first panel to the last panel and the first panel connection feature and the last panel connection feature are brought into mating engagement thereby to form an enclosure;
each panel having a front face, a reverse face, and a printed feature which is self contained on the front face;
printed features on reverse faces of at least two adjacent panels form a thematically overlapping printing feature; and
the first panel connection feature and the last panel connection feature are mating jigsaw cut out shapes in the first panel free end and the last panel free end.

8. A combination as claimed in claim 7 wherein the printing features on reverse faces of all panels form the thematically overlapping printing feature, thereby creating a first wrap around theme.

9. A combination as claimed in claim 8 wherein printing features on the front faces of all panels form an additional thematically overlapping printing feature, thereby creating a second wrap around theme related with the first wrap around theme.

10. A collapsible enclosure comprising a series of panels having a first panel and a second panel, the second panel adjacent to the first panel, at least some of the panels having decorative features; wherein:
the first panel has a first panel free end and the second panel has a second panel free end;
the panels are locatable in end to end relationship, the first panel free end and the second panel free end connectable together when the first panel and the second panel are placed in a relative extended relationship such that the first panel free end and the second panel free end can be brought into contact;
a first panel connection feature of on the first panel See end is for mating engagement with a complementary second panel connection feature on the second panel free end, the enclosure being a substantially circular enclosure formed when the first panel free end is brought into mating engagement with the second panel free end; and
the first panel connection feature and the second panel connection feature are mating jigsaw cut out shapes in the first panel free end and the second panel free end.

11. An enclosure as claimed in claim 10 wherein each panel has a front face, a reverse face, and a decorative feature which is self contained on the front face.

12. An enclosure as claimed in claim 10 wherein each panel has a front face, a reverse face, and a decorative feature which is self contained on the front face, and wherein decorative features on reverse faces of at least two adjacent panels form a thematically overlapping decorative feature.

13. An enclosure as claimed in claim 12 wherein the decorative features on the reverse faces of all panels form the thematically overlapping decorative feature thereby creating a first wrap around theme.

14. An enclosure as claimed in claim 10 wherein each panel has a front face comprising a front face decorative feature and reverse face comprising a reverse face decorative feature, front face decorative features of all panels thematically overlapping to create a front face wrap around theme, and reverse face decorative features of all panels thematically overlapping to create a reverse face wrap around theme, the front face wrap around theme related with the reverse face wrap around theme.

15. An enclosure as claimed in claim 10, wherein the enclosure comprises an open top surface, an open bottom surface, and a substantially circular lateral surface.

16. An enclosure as claimed in claim 10, the enclosure being suitable to contain a child.

17. A combination as claimed in claim 1, wherein the enclosure is substantially circular.

18. A combination as claimed in claim 7, wherein the enclosure is substantially circular.

19. A device suitable to be used by a child, the device comprising a plurality of panels including a first panel and a last panel each panel separated from an adjacent panel by way of a hinge line, the first panel including a first panel free end and the last panel including a last panel free end, the device being able to assume a book condition where the panels are folded along hinge lines, sequentially turnable about the hinge lines, and sequentially readable, and an enclosure condition where the panels are extended to form an open enclosure having an open top and an open bottom, wherein, in the enclosure condition, the first panel free end is connected with the last panel free end and the child is able to be located within the enclosure.

20. The device of claim 19, wherein the enclosure is substantially circular.

22. The device of claim 20, wherein circularity is formed by multiple straight line panels.

22. The device of claim 19, wherein all of the hinge lines are substantially parallel to each other.

23. The device of claim 19, wherein, in the enclosure condition, no hinge lines are contiguous to each other.

24. A device comprising a plurality of panels including a first panel and a last panel, each panel separated from an adjacent panel by way of a hinge line, the first panel including a first panel free end and the last panel including a last panel free end the device being able to assume a book condition where the panels are folded along hinge lines, sequentially turnable about the hinge lines, and sequentially readable as a book, and an enclosure condition where the panels are extended to form an enclosure, wherein all of the hinge lines of the device are substantially in a same direction, and wherein, in the enclosure condition, the first panel free end is connected with the last panel free end.

25. A collapsible enclosure comprising a plurality of panels including a first panel and a last panel, each panel separated from an adjacent panel by way of a hinge line, the first panel including a first panel free end and the last panel including a last panel free end, the first panel free end connectible with the last panel free end, wherein all hinge lines of the enclosure are substantially in a same direction, the panels foldable about the hinge lines in a book condition, wherein, in the book condition, the panels are sequentially turnable about the hinge lines and sequentially readable as a book.

26. A method of providing a combination book and enclosure for a child, comprising:
providing a series of panels having a first panel and a last panel, at least one of the panels having a printed feature wherein:
each two adjacent panels are in end to end relationship around a hinge line so as to be foldable in a fan-like mode, the first panel having a first panel free end and the last panel having a last panel free end,
the fist panel free end and the last panel free end are connectable together when the panels are opened and extended such that the first panel free end and the last panel free end can be brought into contact,
a first panel connection feature on the first panel free end is for mating engagement with a complementary last panel connection feature on the last panel free end,
the panels in a first mode are readable sequentially as a book when successive panels are sequentially turned about hinge lines between the panels, and
the panels in a second mode are extendible from the first panel to the last panel and the first panel connection feature and the last panel connection feature are brought into mating engagement thereby to form an enclosure suitable to include the child; and
providing the child with the series of panels, wherein the child is able to use the combination in the first mode and in the second mode and wherein the child is inside the being inside the enclosure when using the combination in the second mode.
